(19) United States
(12) Patent Application Publication
(10) Pub. No.: US 2016/0006842 A1
(43) Pub. Date: Jan. 7, 2016

(54) FRAME FORMAT SUPPORTING ENHANCED FEATURES IN A COMMUNICATION NETWORK

(71) Applicant: QUALCOMM Incorporated, San Diego, CA (US)

(72) Inventor: Ehab Tahir, Mississauga (CA)

(21) Appl. No.: 14/322,465

(22) Filed: Jul. 2, 2014

(51) Int. Cl. H04L 29/06; H04L 12/741

(52) U.S. Cl. CPC H04L 69/03; H04L 45/74; H04L 69/22

(57) ABSTRACT

Described is a frame format for a protocol data unit (PDU). The frame format may support enhanced features in a communication network. The first frame format is based at least in part on a second frame format that is predefined by a communication protocol. The first frame format may support enhanced features for those devices that know the first frame format and which are capable of interpreting the first frame format. Legacy devices may interpret the PDU as following the second frame format according to the communication protocol. The first frame format may be created by overloading some fields in the second frame format. The first frame format may match parts of the second frame format that are used for contention timing (or other medium synchronization). In one example, the PDU may include an instruction creating a media idle measurement period.

### BACKGROUND

Embodiments of the present subject matter generally relate to the field of network communication, and, more particularly, to frame formats used to transmit information in a communication network.

Communication technology is evolving to allow for better use of a communication medium. For example, in many technologies, such as powerline communication, a communication medium between a first device and a second device may support multi-carrier transmissions and/or higher transmission power levels. Typically, a communication network may operate in accordance with a communication protocol (sometimes also referred to as a standard specification). The communication protocol may define frame formats that are known to devices that comply with the communication protocol. The communication protocol may specify the frame format so that all devices on the communication medium can properly interpret a protocol data unit (PDU) according to the frame format.

Some communication protocols may be limited to standard features that are supported by standard frame formats. Therefore, supporting enhanced features may be difficult using standard frame formats. For example, standard frame formats may not provide for coordination of enhanced features among a group of devices coupled to a communication medium.

### SUMMARY

In this disclosure, various embodiments are described in which a frame format supports enhanced features in a communication network.

In one embodiment, a PDU is transmitted via a communication medium. The PDU has a first frame format that is based at least in part on a second frame format used on the communication medium to determine contention timing. The first frame format is known by a first class of devices and the first frame format differs at least in part from the second frame format without affecting the contention timing for a second class of devices. In one embodiment, a receiving device may determine that the PDU has the first frame format rather than the second frame format, and interpret the PDU based on the first frame format.

In one embodiment of this disclosure, the first frame format may be used to direct a media idle measurement period on the communication medium. A conventional communication protocol may not define a frame format for enhanced features associated with a media idle measurement period. In accordance with this disclosure, a PDU may include an instruction creating a media idle measurement period, and may specify time period for the media idle measurement period that is shorter than a contention timing that would be associated with the second frame format.

Other embodiments of this disclosure may be used to support other enhanced features in a communication network. A conventional communication protocol may not define a frame format capable of supporting the enhanced feature. In accordance with this disclosure, a PDU may use the first frame format that is known by the first class of devices that support the enhanced feature. The first frame format may differ from a second frame format (defined by the conventional communication protocol) without affecting the contention timing for a second class of devices.

### BRIEF DESCRIPTION OF THE DRAWINGS

The present embodiments may be better understood, and numerous objects, features, and advantages made apparent to those skilled in the art by referencing the accompanying drawings.

FIG. 1A depicts an example system diagram illustrating a PDU transmitted by a transmitting device via a communication medium, the PDU may be interpreted differently by different classes of devices in accordance with an embodiment of this disclosure.

FIG. 1B depicts two frame formats that may be used to interpret a PDU in accordance with an embodiment of this disclosure.

FIG. 2 is a flow diagram illustrating example operations for transmitting a PDU in accordance with an embodiment of this disclosure.

FIG. 3 depicts an example system diagram illustrating a media idle measurement in accordance with an embodiment of this disclosure.

FIG. 4 illustrates behavior of devices in a typical contention based communication network.

FIG. 5 illustrates behavior of devices using an enhanced feature of media idle measurement in accordance with an embodiment of this disclosure.

FIG. 6 illustrates behavior of devices using another enhanced feature in accordance with an embodiment of this disclosure.

FIG. 7 is a diagram illustrating an example PHY/MAC frame in accordance with an embodiment of this disclosure.

FIG. 8 is a diagram illustrating an example Ethernet frame in accordance with an embodiment of this disclosure.

FIG. 9 is a diagram illustrating an example IEEE 802.11 frame in accordance with an embodiment of this disclosure.

FIG. 10 is a flow diagram illustrating example operations for causing a media idle measurement period in accordance with an embodiment of this disclosure.

FIG. 11 is a flow diagram illustrating example operations for receiving a PDU to cause a media idle measurement period in accordance with an embodiment of this disclosure.

FIG. 12 is a flow diagram illustrating example operations associated with a media idle measurement period in accordance with an embodiment of this disclosure.

FIG. 13 is an example block diagram of an electronic device including a communication unit in accordance with an embodiment of this disclosure.

### DESCRIPTION OF EMBODIMENT(S)

The description that follows includes exemplary systems, methods, techniques, instruction sequences and computer program products that embody techniques of the present subject matter. However, it is understood that the described embodiments may be practiced without these specific details. In other instances, well-known instruction instances, protocols, structures and techniques have not been shown in detail in order not to obfuscate the description.

Although examples in this disclosure refer to powerline communication (PLC) networks, similar embodiments may be conceived for a variety of contention based communication networks. Examples of contention based communication networks include, without limitation, powerline communication (PLC) networks, Ethernet, WLAN, coax, carrier detection multiple access (CDMA), carrier sense multiple access (CSMA), and the like. Furthermore, although examples in this disclosure refer to a protocol data unit (PDU) (sometimes interchangeably referred to as a frame), similar embodiments may be conceived for a variety of other media control transmission units, including, without limitation, an integrated physical layer (PHY)/medium access control (MAC) frame, an Ethernet frame, a wireless local area network (WLAN, such as IEEE 802.11) frame, or other physical layer transmission frame, or MAC layer or logical link control (LLC) layer protocol data units.

Using a communication protocol, a receiving device can determine when it can contend for access to the communication medium following a PDU. Contention timing refers to the next time period in which a device can contend for access to the communication medium. Contention timing may be determined based on the frame format and transmission period for a PDU. There may be a reason to create a new frame format to support enhanced features in a communication network. The new frame format and enhanced features may or may not be specified for the communication protocol. For example, a vendor-specific frame format could be used to communicate information regarding proprietary features.

A traditional communication protocol may not be conducive to creating a new frame format. Often, the frame format cannot be altered from predefined frame types recognized by specification-compliant devices. Communication protocols may define multiple frame formats and use a “type” field or other header to indicate which frame format is used for a particular PDU. However, there may be limited values that can be used to populate the “type” field, and values may be reserved for future versions of the communication protocol.

In accordance with this disclosure, a new frame format may be defined based on a predefined frame format. The new frame format may be created by overloading (or changing the meaning) of one or more fields in the predefined frame format. The new frame format may match parts of the predefined frame format that are used for contention timing (or other medium synchronization). For example, the address fields may be overloaded to provide additional meaning for devices that can interpret overloaded address fields. In one example, a new frame format may use a same address value for the destination and the source address fields. For example, a transmitting device may use its address (or the address of another device of the first class or devices) as the source address and the destination address. Legacy devices may interpret the PDU using the predefined frame format and ignore the PDU when it is not addressed to them while enhanced devices may interpret the PDU using the new frame format upon determining that the PDU has the same source address and destination address.

There may be many examples of enhanced features which could be enabled via a new frame format. One example enhanced feature is a media idle measurement period. Other enhanced features may allow for aggregation of data, use of different coding rates for sections of a PDU, adding repeated PDUs or acknowledgements, or for optimizing the use of the communication medium during a channel access opportunity. Although the examples in this disclosure refer to media idle measurement periods for brevity, this disclosure may be used with a variety of enhanced features in a contention based communication network.

In accordance with an embodiment of this disclosure, a frame format may be used to specify the media idle measurement period on the communication medium. A media idle measurement period refers to a period of inactivity (sometimes interchangeably referred to as simply “idle period” or “quiet period”) during which time one or more of the communication devices can detect for signals from another system on the communication medium or calibrate transceiver circuitry based upon idle channel conditions. A media idle measurement period may be used to detect for concurrent transmissions from another system.

As communication networks are deployed, particular frequencies may be reserved or allocated by regulatory bodies to prevent overlapping use by multiple communication systems. Use of particular frequencies and/or power levels of frequencies may be contingent on refraining from using the frequencies and/or reducing power levels during a concurrent use by another system. Current communication protocols may not provide a mechanism to detect for a concurrent use. For example, in traditional PLC networks there may not be guaranteed periods of inactivity during which a reliable idle measurement could be performed. The powerline communication network may be unpredictably consumed with traffic between various unpredictable remote devices. The communication protocol may not have a frame format associated with creating a media idle measurement period on the communication medium. In accordance with this disclosure, a new frame format may be capable of directing a media idle measurement period to devices that are able to interpret the new frame format without affecting the contention timing for other devices.

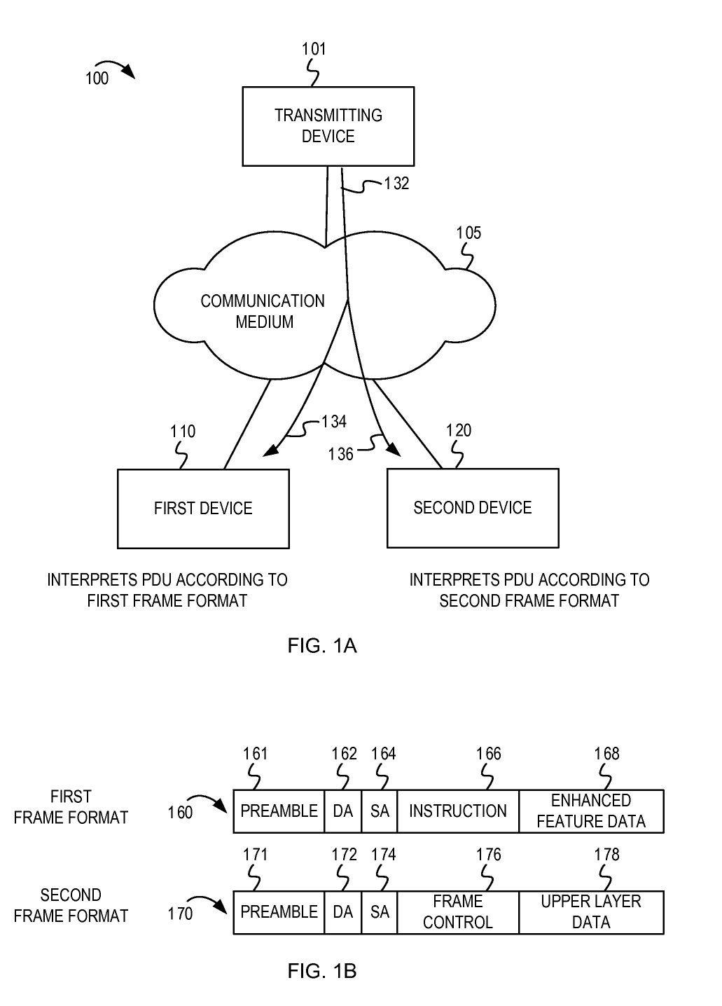

FIG. 1A depicts an example system 100 where a PDU 132 is transmitted by a transmitting device 101. The transmitting device 101, a first device 110, and a second device 120 are communicatively coupled to a communication medium 105. The communication medium 105 may be, for example, a PLC medium. In FIG. 1A, the first device 110 represents a device of a first class of devices (e.g., an enhanced device). The second device 120 represents a device of a second class of devices (e.g., a legacy device).

The transmitting device 101 may transmit a PDU 132 via the communication medium 105. Both the first device 110 and second device 120 may detect the transmission of the PDU 132 and begin receiving the PDU 132. The first device 110 and second device 120 may inspect the headers of the PDU 132 to determine the contents of the PDU 132. However, the first device 110 and the second device 120 may interpret the PDU 132 based on their respective class of device. In FIG. 1A, only the first device 110 may be capable of determining that the PDU 132 was created using a first frame format (which may referred to in this disclosure as a new frame format or modified frame format) that supports enhanced features. Therefore, the first device 110 may then interpret (shown as arrow 134) the PDU 132 according to the first frame format. The second device 120 belongs to a second class of devices and may not be capable of detecting that the PDU 132 was created using the first frame format. For example, the second device 120 may be a legacy device that does not know about the first frame format. However, the PDU 132 was created in such a way that the PDU 132 can also be interpreted according to a second frame format (which may be referred to in this disclosure as predefined frame format, or legacy frame format). As such, the second device 120 may interpret (shown as arrow 136) the PDU 132 according to the second frame format. Therefore, although the same PDU 132 was transmitted by the transmitting device 101, the first device 110 may interpret (parse) the PDU 132 differently than the second device 120.

FIG. 1B illustrates a first frame format 160 and a second frame format 170 which could be used by the first device 110 and second device 120, respectively, to interpret the same PDU 132. Each PDU (also referred to as a “frame”) has a number of fields, and each field may be defined by a frame format. As stated previously, the frame format may be specified for the communication protocol. In FIG. 1B, the second frame format 170 is an example of a standard frame format that may be defined by a communication protocol. The second frame format 170 includes a preamble 171, and fields for a destination address 172 (“DA”), a source address 174 (“SA”), a frame control header 176, and upper layer data 178. Other fields could be defined, but for brevity, FIG. 1B shows only a subset of the fields defined by the communication protocol. The second device 120 in FIG. 1A may interpret PDU 132 using the second frame format 170.

A first frame format 160 may be based on the second frame format 170 but may redefine one or more fields of the second frame format 170. The first frame format 160 includes a preamble 161, DA 162, SA 164, instruction field 166, and enhanced feature data field 168. The preamble 161, DA 162, SA 164, and instruction field 166, may have the same timing and frame format structure as the preamble 171, DA 172, SA 174, and frame control 176, respectively, of the second frame format 170. The frame control field 176 from the second frame format 170 has been redefined to support an instruction field 166 associated with an enhanced feature. Similarly, the upper layer data field 178 of the second frame format 170 has been redefined to support enhanced feature data 168 associated with the enhanced feature.

The PDU 132 may be transmitted using the first frame format 160 and may include information regarding enhanced features in those fields which have been redefined for enhanced features. Meanwhile, devices that are not capable of interpreting the PDU 132 using the first frame format 160 may still be able to interpret the PDU using the second frame format 170. In FIG. 1A, the second device 120 may receive the PDU 132 and interpret it according to the second frame format 170, even though the PDU 132 was transmitted using the first frame format 160. Because the DA, SA have the same timing between both frame formats, the second device 120 may interpret the PDU 132 as having DA 172 and SA 174, and inspect those headers to determine whether to continue interpreting the rest of the PDU 132. The first device 110 may interpret the PDU 132 and determine that the PDU was transmitted using the first frame format 160. For example, the first device 110 may interpret the PDU 132 as having DA 162 and SA 162, and inspect those headers to determine that the PDU 132 will include the instruction field 166 and enhanced feature data 168 directed to the first class of devices.

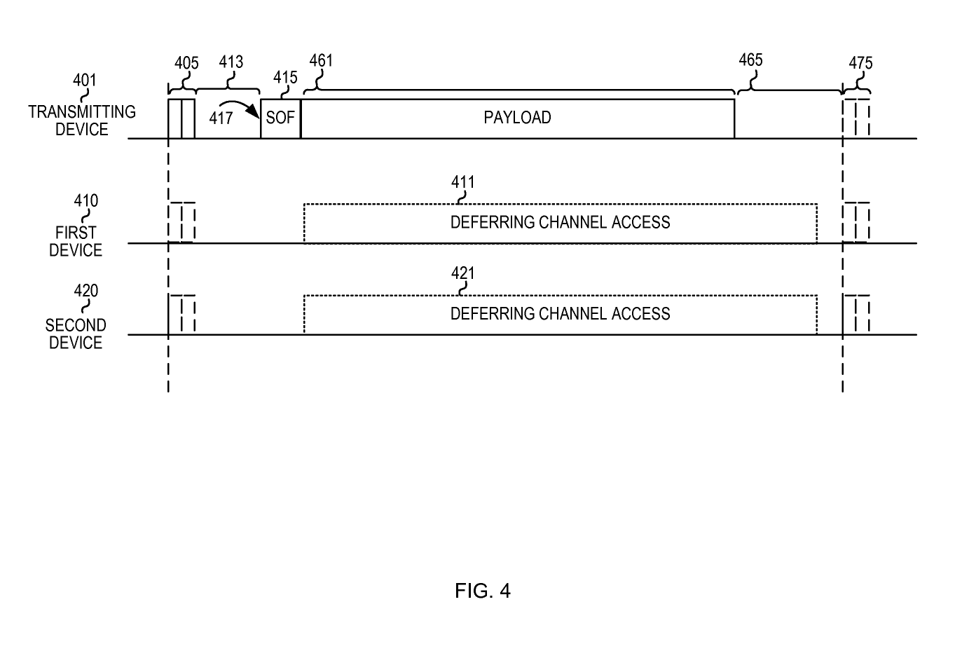

In one embodiment, the fields of the second frame format that are redefined as different fields in the first frame format may be fields that do not affect contention timing. In a contention based communication medium, contention timing is used by devices to determine when they can contend for access to the communication medium. Contention timing is further described in FIG. 4. One feature of the present disclosure is that even though the PDU uses the first frame format, the PDU does not affect contention timing for legacy devices that interpret the PDU using the second frame format. Devices coupled to the communication medium can determine contention timing based on the PDU (according to a standard frame format of a communication protocol) even when the PDU includes information for enhanced features that may not be specified in the communication protocol. For example, the redefined fields (such as instruction 166 and enhanced feature data 168) may be fields that devices (such as second device 120) of the second class of devices would otherwise ignore (such as frame control 176 and upper layer data 178) if the PDU is not addressed to them.

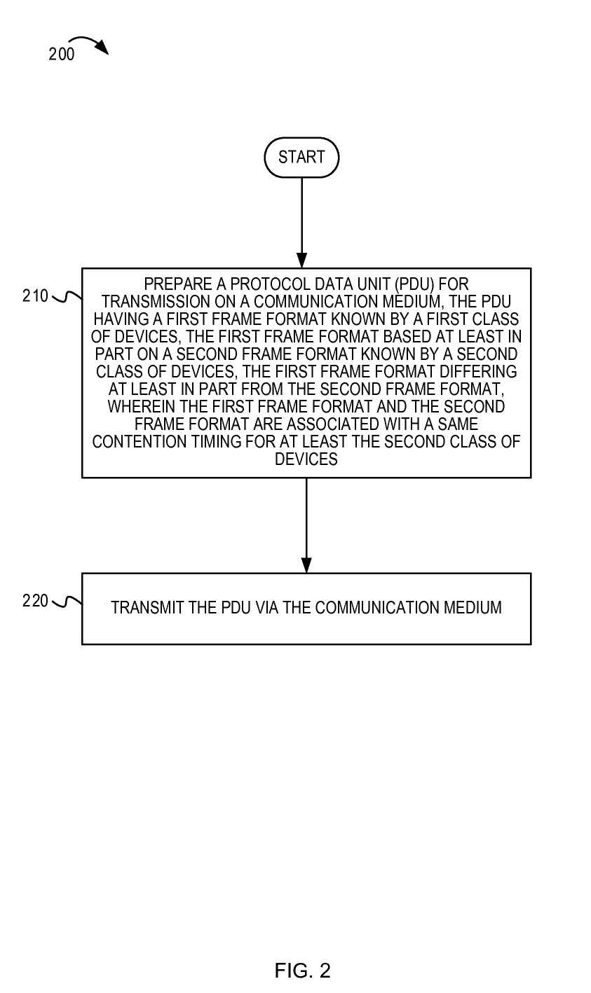

FIG. 2 is a flow diagram illustrating example operations (flow 200) for transmitting a PDU in accordance with an embodiment of this disclosure. At block 210, a transmitting device may prepare a PDU for transmission on a communication medium. The PDU may have a first frame format known by a first class of devices. The first frame format may be based at least in part on a second frame format known by a second class of devices. The first frame format may differ at least in part from the second frame format. The first frame format and the second frame format may be associated with a same contention timing for at least the second class of devices. At block 220, the transmitting device may transmit the PDU via the communication medium.

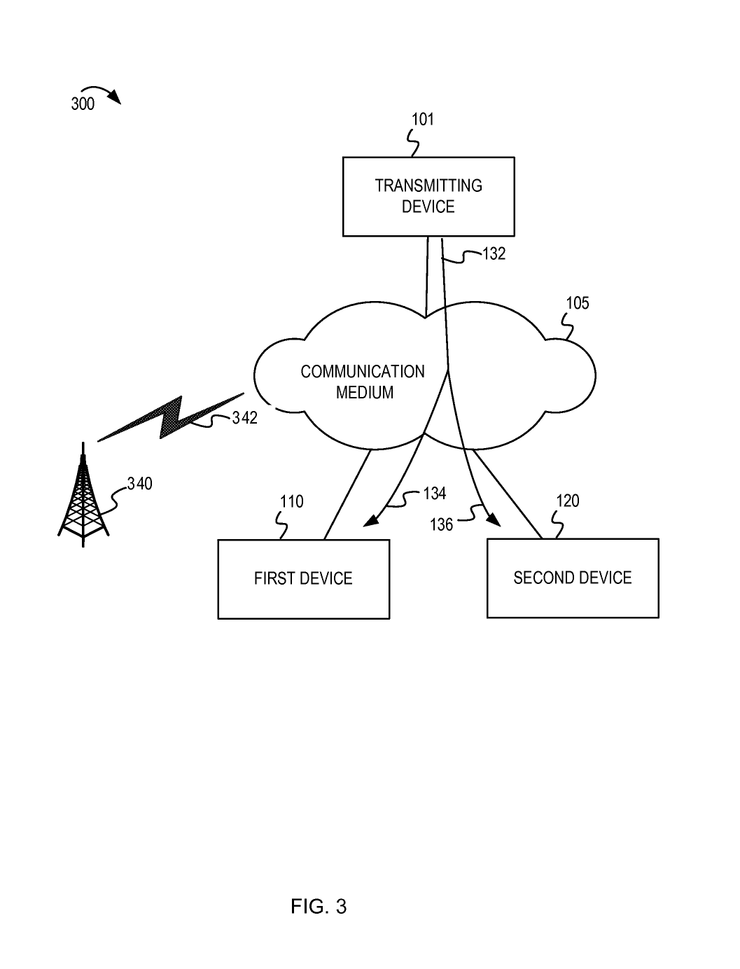

FIG. 3 depicts an example system diagram 300 illustrating a media idle measurement in accordance with an embodiment of this disclosure. A media idle measurement period may be used to detect for noise, interference, or protected signals that are present on a communication medium during an idle period.

Regulatory bodies may require devices coupled to a communication network to limit transmissions at particular frequencies. For example, a dynamic frequency exclusion feature may require a powerline communication device to limit transmission power for certain frequencies or frequency ranges upon detecting a valid transmission from another source. A device is required to detect the valid transmission and adjust the transmit power levels to ensure that the device does not interfere with any ongoing valid transmissions. Alternatively, the device may refrain from using the frequency associated with the valid transmission.

In order for the device to detect the valid transmission, it may be desirable to force all powerline communication devices to observe media idle measurement period during which time one or more of the powerline communication devices can detect for the presence of valid radio broadcast interference (or other signals ingressing from a foreign communication system). In accordance with some embodiments of this disclosure, a first frame format may include a directive to cause a media idle measurement period on a communication medium. The media idle measurement period may allow for detection of radio broadcast interference, noise, or other signals from a foreign communication system.

In FIG. 3, the transmitting device 101, first device 110, and second device 120 are coupled to communication medium 105. FIG. 3 also includes a radio broadcast tower 340 and signals 342 from the radio broadcast tower 340 that may or may not be inadvertently absorbed and conducted by the communication medium 105. The transmitting device 101 may prepare a PDU 132 for transmission via the communication medium 105. Similar to FIG. 1A, the PDU 132 may be formatted using a first frame format which is based on a second frame format. The PDU may include a directive associated with causing a media idle measurement period on the communication medium 105.

In one embodiment, the PDU 132 may be modified to include information about the media idle measurement period. For example, the first device 110 may include a time period for the media idle measurement period. The PDU 132 may also include an empty payload field (or portion of the payload field) to provide time for the media idle measurement period during a transmission period associated with the PDU 132. For example, the first frame format may include a first portion of the payload field to indicate the duration of the media idle measurement period, and a second portion of the payload field may be empty, causing an idle period.

The first device 110 may interpret the PDU 132 and determine that the media idle measurement period occurs during the transmission period of the PDU 132. If, the first frame format includes a duration for the media idle measurement period, the first device 110 may also contend for access to the communication medium 105 following the media idle measurement period. Since the media idle measurement period may be shorter than the transmission time associated with the PDU 132, it may be possible for the first device 110 to contend for access to the communication medium sooner than a normal contention timing that would otherwise be associated with the second frame format.

The second device 120 may detect the PDU 132 and interpret the PDU 132 using the second frame format (shown as arrow 136). The second device 120 may determine contention timing based on the second frame format and refrain from transmitting until the next contention timing. As such, the second device 120 may honor the media idle measurement period due to normal contention timing. However, if the second device 120 cannot interpret the PDU 132 using the first frame format, the second device 120 may not obtain the extra information (e.g., time period) for the media idle measurement period. The second device 120 may not benefit from the enhanced feature of faster contention after the media idle measurement period and may wait until normal contention timing before attempting to contend for access to the communication medium.

The communication medium 105 may be idle for at least the media idle measurement period during which time one or more devices may detect for the presence of radio broadcast interference or perform idle circuit calibration procedures. In the example of FIG. 1A, the first device 110 may detect the presence of radio broadcast signals 342 from a transmitting radio broadcast device 340. Although the radio broadcast device 340 may or may not have directly coupling to the communication medium 105, the communication medium 105 may nonetheless still absorb and conduct radio energy from the transmitting radio broadcast device 340. The media idle measurement period provides a period of inactivity on the contention based communication medium for the first device 110 (or any device of the first class of devices) to detect for presence of radio broadcast interference or to perform channel characteristics measurements.

FIG. 4 illustrates prior art behavior of devices in a typical contention based communication network. The example of FIG. 4 is based on a PLC network using conventional frame format. The PLC network may implement CSMA to limit interfering transmissions. The CSMA protocol has been adopted by MAC protocols used in various multi-access communication systems (e.g., wireless/powerline LANs). In CSMA, a device may determine if the channel is being used by other devices in the network by sensing the communication medium. If the channel is currently occupied, the device defers its transmission until the channel becomes available. Otherwise, the device may access the channel with a certain probability which, in practice, is implemented by backing off the transmission for a short time period, where the back-off period length depends on the channel access probability.

Similar to the MAC protocol used in wireless local area networks (e.g., IEEE 802.11 WLANs), the MAC protocol commonly used in PLC networks belongs to the CSMA family of protocols. When a transmitting device 401 has a PDU to transmit and the channel is not occupied, transmitting device 401 may contend for access to the PLC medium. During contention, the transmitting device 401 may send its priority symbols in the two priority resolution (PRS) slots 405. The priority symbols may indicate the transmission priority of the transmitting device's pending PDU. For another device with lower transmission priority than transmitting device 401, that other device may yield the channel to the device having higher priority (e.g., transmitting device 401). After sending its priority symbols in the two PRS slots, if the transmitting device 401 does not lose the channel contention due to priority, transmitting device 401 may initiate random back-off procedure 413 by randomly selecting a number of contention slots from a specified range. If the channel is still free after the back-off procedure 413 ends, transmitting device 401 may start to transmit its PDU 417. The PDU 417 may include a MAC layer header called the Start-of-Frame (SOF) delimiter 415, in which some control information. A PDU transmission period 461 may be determined based on control information (not shown) in the SOF delimiter 415. The SOF delimiter 415 may include a destination address of a receiving device (not shown) or a broadcast address. Following transmission of the PDU 417, extra time 465 may be provided for a response inter-frame space (RIFS) time period, an acknowledgement time period, and a contention interframe space (CIFS) time period. Following the extra time 465, the next PRS slots 475 provide another contention timing opportunity for any of the devices to transmit priority symbols in the next PRS slots 475 if they have data to transmit.

Based at least in part on the transmission time information in the SOF delimiter 415, and calculations regarding the PDU transmission period 461 and extra time 465, the first device 410 and second device 420 may determine the contention timing for the next PRS slots 475. The first device 410 and second device 420 may start medium/channel access deferral time periods 411, 421, respectively, and resume contention for the channel after the current transmission completes.

Using the timing of FIG. 4 as an example, the transmitting device 401 may transmit a traditional PDU using the frame format described for the SOF delimiter 415. However, the SOF delimiter 415 may not be extensible for a new frame type value and may not be large enough to include an indicator or instruction regarding a media idle measurement period. There may be no way for the transmitting device 401 to indicate the media idle measurement period in the SOF delimiter 415 using the predefined frame formats associated with the communication protocol for the PLC medium.

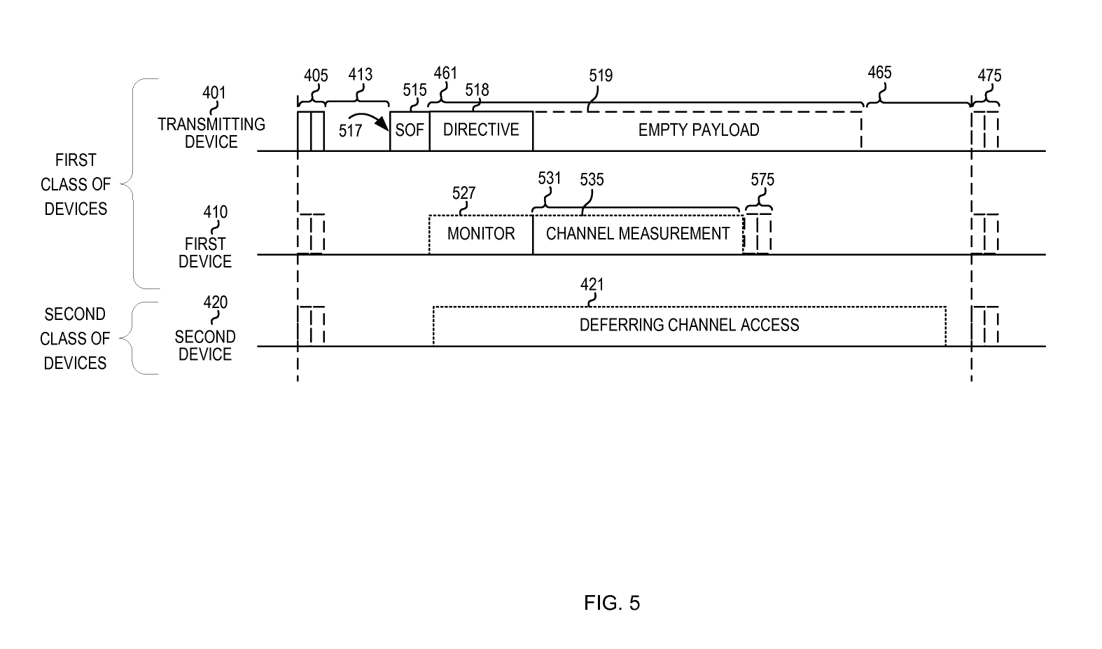

FIG. 5 illustrates behavior of devices using an enhanced feature of media idle measurement in accordance with an embodiment of this disclosure. In FIG. 5, the transmitting device 401 modifies the SOF delimiter 515 in a way that does not affect the contention timing for the second device 420, but in a way that the first device 410 detects that the PDU 517 is associated with a frame format supporting an enhanced feature. For example, the SOF delimiter 515 may utilize a same address for the source address and destination address. The same address may be a MAC address of the transmitting device 401. A traditional broadcast address may not be used in some embodiments, because the second device 420 may not be capable of parsing the frame format for the PDU 517. A traditional unicast address may direct the PDU 517 to a single device. However, transmitting device 401 may send the PDU 517 to many or all enhanced devices that are coupled to the communication medium, so that the enhanced devices may concurrently take advantage of the media idle measurement period or shortened contention timing.

In the example of FIG. 5, the SOF delimiter 515 includes the MAC address of the transmitting device 401 in a source address field and a destination address field. Following the SOF delimiter 515, the PDU 517 may include information (referred to as an instruction or directive 518) about the media idle measurement period in a first portion of the payload field. Alternatively, the directive 518 may be included in a different header within the PDU 517.

Fields within the PDU 517 that are not used for medium synchronization could have their meaning change to convey the directive, or other vendor specific information. For example, in the HomePlug™ AV protocol, a ToneMap field indicates which physical layer (PHY) properties were used to encode the PDU. In the new frame format, the meaning of the ToneMap field could be redefined to convey different information regarding the media idle measurement period (such as a time period).

Fields within the PDU 517 that are used for medium synchronization may have the same meaning as a predefined frame format for the communication protocol. For example, a Frame Length field which indicates the duration of the PDU 517 may remain unchanged so that the second device 420 (or other legacy devices of a second class of devices) would still remain properly synchronized with the contention timing on the communication medium.

Returning to the example in FIG. 5, the PDU 517 includes a directive 518 with information about the media idle measurement period. Specifically, the directive 518 includes a time period for the media idle measurement period 531. The first device 410 is an enhanced device of a first class of devices that can detect the new frame format and monitor 527 for the directive 518. The first device 410 may then perform a channel measurement 535 during the media idle measurement period. It is noted that the transmitting device 401 may also perform a channel measurement (not shown) during the media idle measurement period. The transmitting device 401 may also cease transmission for part of the transmission period 461 associated with the PDU 517. For example, the transmitting device 401 may refrain from transmitting or may transmit an empty payload field 519 such that the transmitting device 401 is idle during the media idle measurement period. The media idle measurement period may be shorter than the empty payload field 519 in some embodiments.

In addition to the first device 410, other devices of the first class of device (not shown) may detect that the PDU 517 is structured using the new frame format based on information in the SOF delimiter 515. The other devices may also detect the directive 518 and may perform channel measurements during the media idle measurement period 531.

Following the media idle measurement period 531, the first device 410 (or other devices of the first class of devices) may contend for access to the communication medium at early PRS slots 575 following the media idle measurement period 531. It will be appreciated that the early PRS slots 575 may occur sooner than the traditional contention timing for the next PRS slots 475. Devices of the first class of devices (such as first device 410) may take advantage of the early PRS slots 575 because they are capable of detecting the directive 518 according to the new frame format. Other devices of the second class of devices (such as second device 420) may not detect the directive 518 and may defer channel access 421 until the next PRS slots 475.

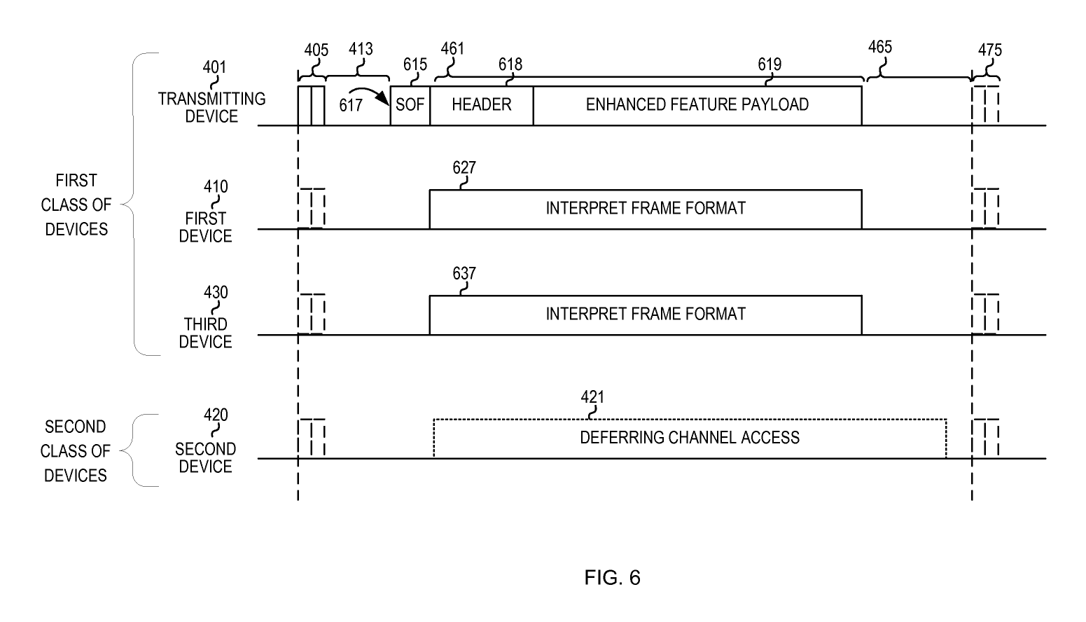

FIG. 6 illustrates behavior of devices using another enhanced feature in accordance with an embodiment of this disclosure. Similar to FIG. 5, the transmitting device 401 may modify the SOF delimiter 615 in a way that does not affect the contention timing for a second device 420 of a second class of device, but in a way that the first device 410 and third device 430 detects that the PDU 617 is associated with a frame format supporting an enhanced feature. For example, the SOF delimiter 615 may use a same address (e.g., the MAC address of the transmitting device 401) in a source address field (not shown) and a destination address field (not shown). The use of the same address may be an indicator to devices of the first class of devices that the PDU 617 is directed to many enhanced devices (e.g., the first class of devices that are coupled to the communication medium. In FIG. 6, the first device 410 and a third device 430 are coupled to the communication medium.

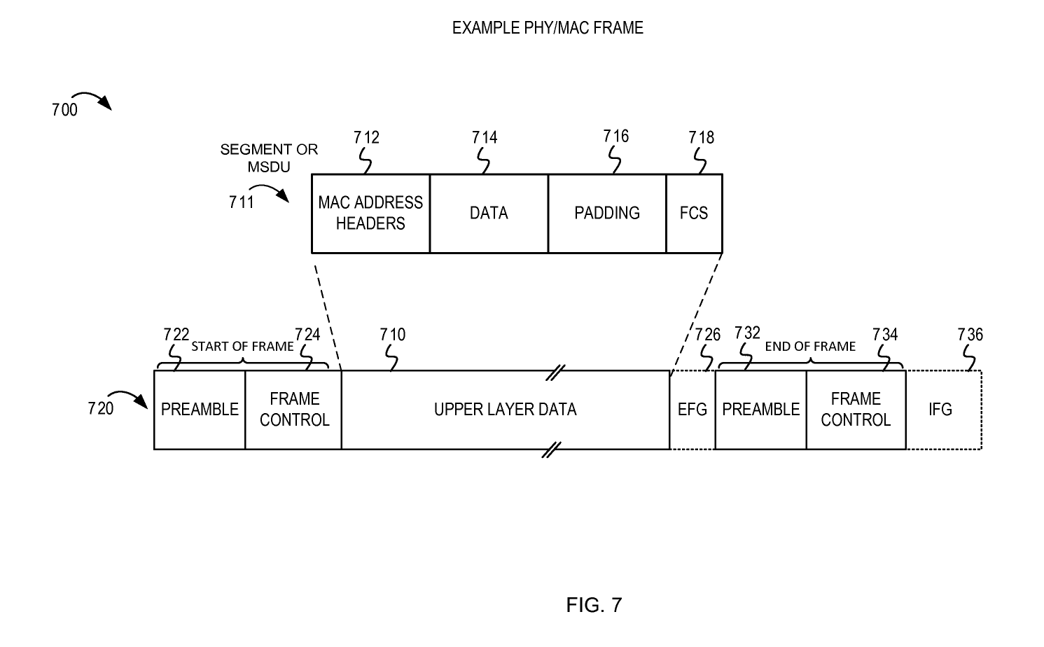

The PDU 617 may include one or more headers, such as header 618 with information about how the PDU transmission period 461 should be interpreted. The enhanced feature payload 619 may include information directed to devices of the first class of devices. In one example, the enhanced feature payload 619 may be used to aggregate sub PDUs (or MSDUs, described in FIG. 7) which may be addressed to ones of the first class of devices. The sub PDUs could have shorter preambles and frame headers. In one variant, the sub PDUs could also be modulated using different physical (PHY) layer properties that are optimized for the different destination devices. The enhanced feature payload 619 may allow a transmitting device 401 to send data to multiple devices (such as first device 410 and third device 430) within a single PDU transmission opportunity and avoid channel access overhead that might otherwise be used for multiple transmissions. The enhanced feature payload may also include retransmissions of portions of data, acknowledgement information, or other data that could be structured in the enhanced feature payload 619.

The first device 410 and third device 430 are devices of the first class of devices and are capable of interpreting the PDU 617 using a first frame format (e.g., new frame format to support enhanced features). In response to determining from the SOF delimiter 615 that the PDU 617 is structured using the first frame format, the first device 410 and third device 430 may interpret the PDU 617 using the first frame format.

The second device 420 belongs to a second class of devices (e.g., legacy devices that do not support the enhanced feature). The second device 420 may interpret the SOF delimiter 615 using the second frame format (e.g., legacy frame format) and determine to ignore the remaining part of the PDU 617. However, the second device 420 can determine the PDU transmission period 461 and extra time 465 based on the SOF delimiter 615. The second device 420 may defer channel access 421 until the next PRS slots 475 determined based on the PDU transmission period 461 and extra time 465.

FIG. 7 is a diagram illustrating an example PHY/MAC frame 700 that can be used in various embodiments of this disclosure. In FIG. 7, a portion of the PHY/MAC PDU 720 comprises a payload portion 710 for upper layer data. The payload portion 710 may include one or more data segments or MAC service data units (SDUs), such as MAC SDU 711. Typically the segment or MAC SDU 711 (also referred to as MSDU) comes from upper layers of the protocol stack. The MAC SDU 711 includes MAC headers 712 (such as destination MAC address and source MAC address), data 714, and may include padding 716 and a frame check sequence (FCS) 718 (e.g., CRC or checksum). The MAC SDU 711 is encapsulated in the PHY/MAC PDU 720. The PHY/MAC PDU 720 includes a preamble 722 used as part of the start of frame delimiter signaling the beginning of the PHY/MAC frame. A frame control field 724 follows the preamble 722 as part of the start of frame delimiter. The frame control field 724 may include a contention control value, a delimiter type, a variable field, and a frame control check sequence (FCCS). The delimiter type is sometimes referred to as a “type” field. Other terms for type portion may include an Ethertype field, or frame type field.

Following the preamble 722 and frame control field 724, the segment or MAC SDU 711 may be included. An end of frame gap (EFG) 726 follows the payload portion 710 to provide a short pause in the transmission before the end of frame delimiter. The end of frame delimiter includes a further preamble 732 and further frame control field 734. After the end of frame delimiter, an inter-frame guard (IFG) period 736 provides a period of time following the PHY/MAC frame before transmission of a next PHY/MAC frame.

In one embodiment, the MAC headers 712 field may be redefined to include a same address for both a source address and a destination address. When the same address is used for both the source address and the destination address, the data 714 field may be split into a directive portion (not shown) and an empty payload portion (not shown). The directive portion may be used to indicate a time period for a media idle measurement period, and the empty payload portion may provide a period of inactivity during which the media idle measurement period occurs. It should be noted that the directive portion may include further information (e.g., configurations, settings, or parameters) about the media idle measurement period. Examples of variable information related to media idle measurement periods may include, without limitation, a duration of the media idle measurement period, a periodic frequency for a series of media idle measurement periods, a delay before beginning the media idle measurement period, or specific frequencies (e.g., a subset of the frequencies in the communication channel) that are included in the media idle measurement period.

In some devices, media idle measurement (such as for the detection of radio broadcast signals) may be performed much quicker than a transmission period associated with the communication channel. For example, when a media idle measurement period is instructed by a directive in a PDU, the time period for the media idle measurement period may be shorter than the contention timing that would otherwise be associated with the PDU.

In some embodiments, the PHY/MAC PDU 720 can include multiple MAC SDUs. MSDU aggregation refers to including MAC SDUs for one or multiple destinations and in a single PHY/MAC PDU 720. In one implementation, MSDU aggregation can be used when multiple MAC SDUs have same receiver address (RA) (e.g., all the MAC SDUs are intended to be received by a single receiver). In an enhanced feature, MSDU aggregation may be used in the new frame format when several MAC SDUs are directed to more than one device of the first class of devices. The MAC SDUs may be addressed to different ones of the first class of devices that are configured to receive a PHY/MAC PDU 720 having the new frame format.

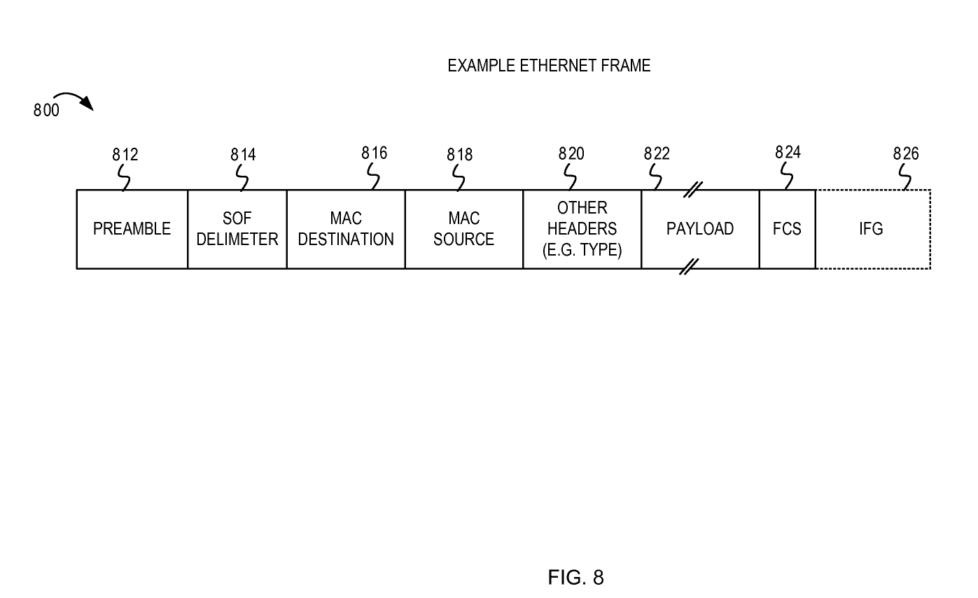

FIG. 8 is a diagram illustrating an example Ethernet frame 800 that can be used in various embodiments of this disclosure. The Ethernet frame comprises a preamble 812, a SOF delimiter 814, a MAC destination 816, a MAC source 818, other headers 820 (e.g., an Ethertype or other type field, virtual local area network VLAN tag, or other headers), payload data 822, and a frame check sequence 824 (e.g., checksum or CRC). An inter-frame guard period 826 (not part of frame transmission) may also be associated with providing a period of time following the frame before a subsequent frame may be transmitted.

Similar to the PHY/MAC frame 700 in FIG. 7, the Ethernet frame 800 may also be modified in accordance with this disclosure. For example, the MAC destination 816 and MAC source 818 may be set to a same address to indicate that the Ethernet frame 800 is using a new frame format. When the MAC destination 816 and MAC source 818 are set to a same address, the other headers 820 may be redefined to convey a directive or other information. For example, the other headers 820 may be used to support enhanced features such as a media idle measurement period on the Ethernet communication medium.

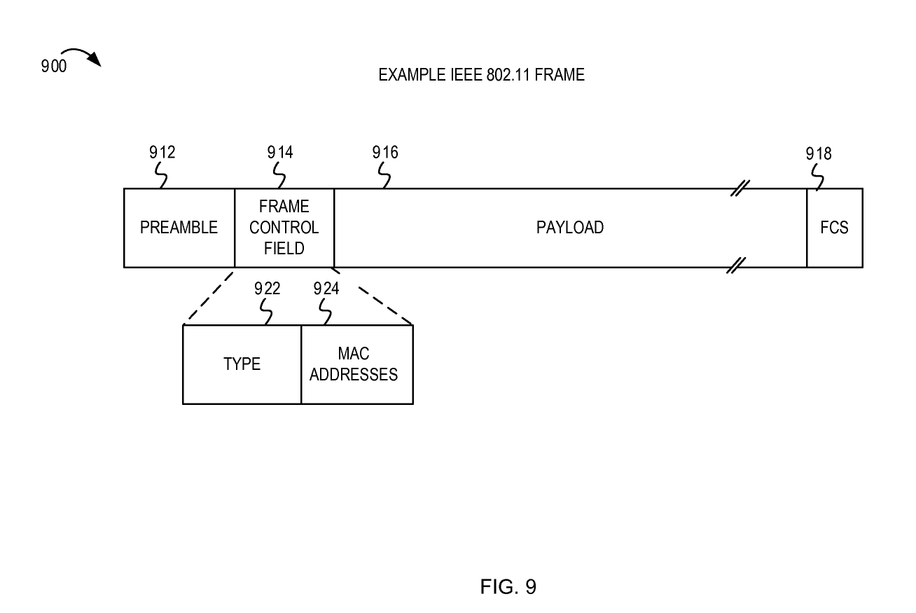

FIG. 9 is a diagram illustrating an example IEEE 802.11 frame 900 that can be used in various embodiments of this disclosure. The IEEE 802.11 frame 900 comprises a preamble 912, frame control field 914, payload 916, and FCS field 918. The frame control field 914 may comprise a type field 922 and one or more MAC addresses 924.

Similar to the PHY/MAC frame 700 in FIG. 7, the IEEE 802.11 frame 900 may also be modified in accordance with this disclosure. For example, MAC addresses 924 may be set to a particular value or to duplicate addresses to indicate that the payload 916 includes a directive portion (not shown) regarding enhanced features. The directive portion may be used to instruct a media idle measurement period for a group of devices that are capable of detecting the directive.

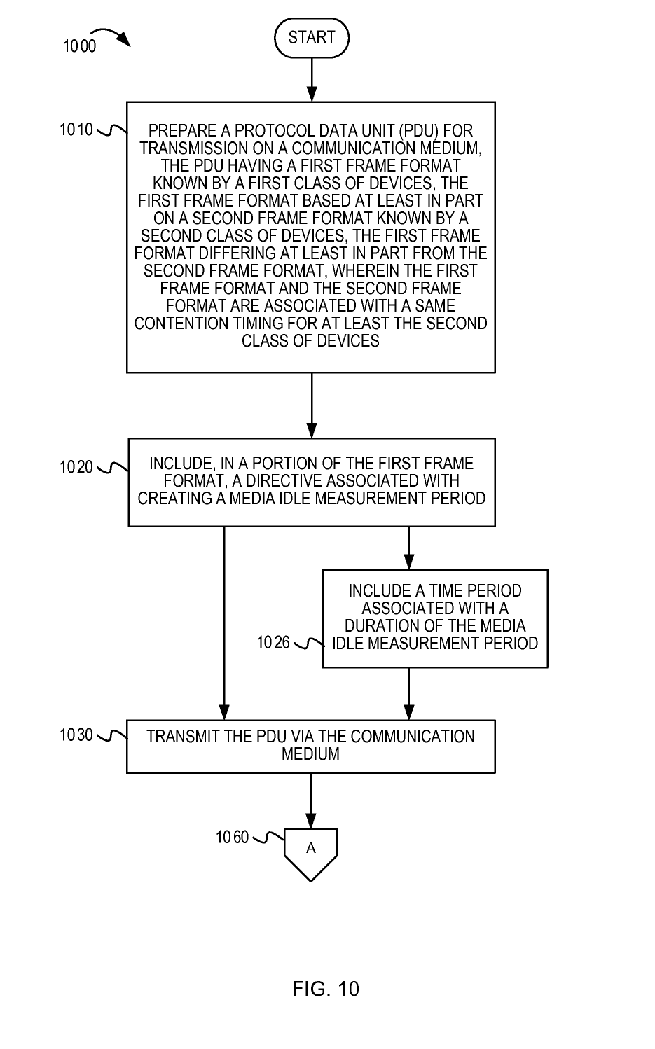

FIG. 10 is a flow diagram 1000 illustrating example operations for a transmitting device to cause a media idle measurement period in accordance with embodiments of this disclosure. At block 1010, a transmitting device may prepare a protocol data unit (PDU) for transmission on a communication medium. The PDU may have a first frame format known by a first class of devices. The first frame format may be based at least in part on a second frame format known by a second class of devices. The first frame format may differ at least in part from the second frame format. The first frame format and the second frame format are associated with a same contention timing for at least the second class of devices.

At block 1020, the transmitting device may include, in a portion of the first frame format, a directive associated with creating a media idle measurement period. At block 1026, the transmitting device may also include a time period associated with a duration of the media idle measurement period. At block 1030, the transmitting device may transmit the PDU via the communication medium.

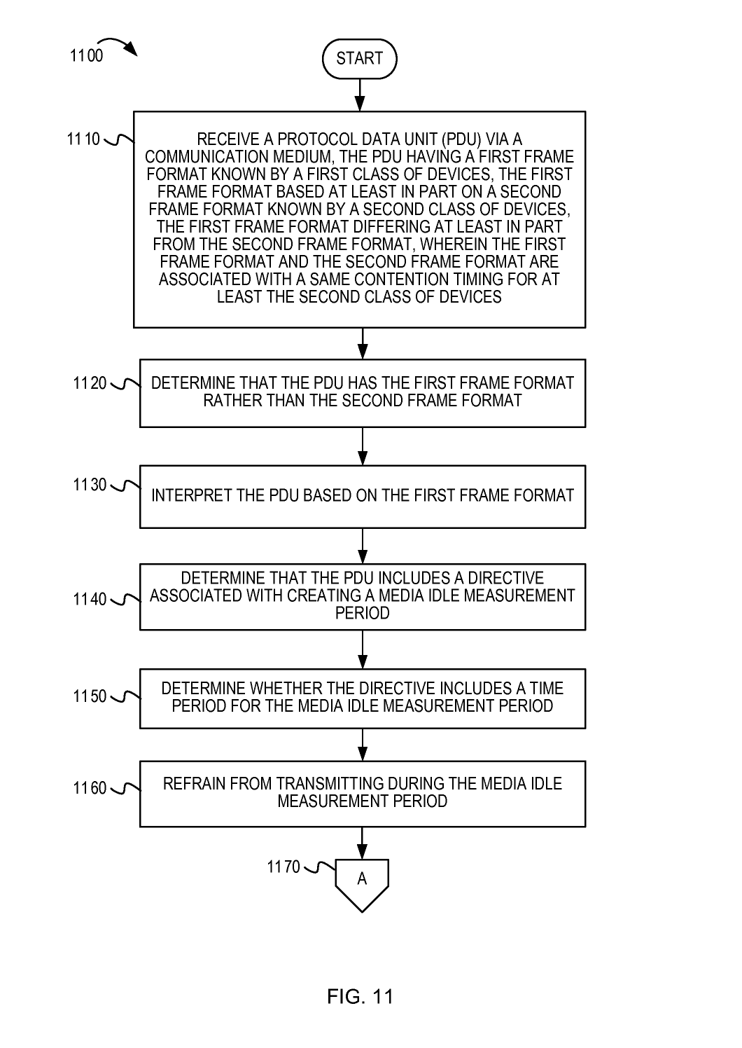

At block 1060 (“marker A”), the transmitting device may perform media idle measurement operations described in FIG. 11.

FIG. 11 is a flow diagram 1100 illustrating example operations for receiving a PDU to cause a media idle measurement period in accordance with an embodiment of this disclosure. The flow diagram 1100 is performed from the perspective of one or more devices of a first class of devices capable of detecting an enhanced frame format.

At block 1110, a receiving device may receive a PDU via a communication medium, the PDU having a first frame format known by a first class of devices, the first frame format based at least in part on a second frame format known by a second class of devices, the first frame format differing at least in part from the second frame format, wherein the first frame format and the second frame format are associated with a same contention timing for at least the second class of devices.

At block 1120, the receiving device may determine that the PDU has the first frame format rather than the second frame format. At block 1130, the receiving device may interpret the PDU based on the first frame format. For example, the receiving device may examine the PDU for a directive included in a directive portion of the first frame format. At block 1140, the receiving device may determine that the PDU includes a directive associated with creating a media idle measurement period. At block 1150, the receiving device may determine whether the directive includes a time period for the media idle measurement period.

At block 1160, the receiving device may refrain from transmitting during the media idle measurement period. At block 1170 (“marker A”), the transmitting device may perform media idle measurement operations described in FIG. 11.

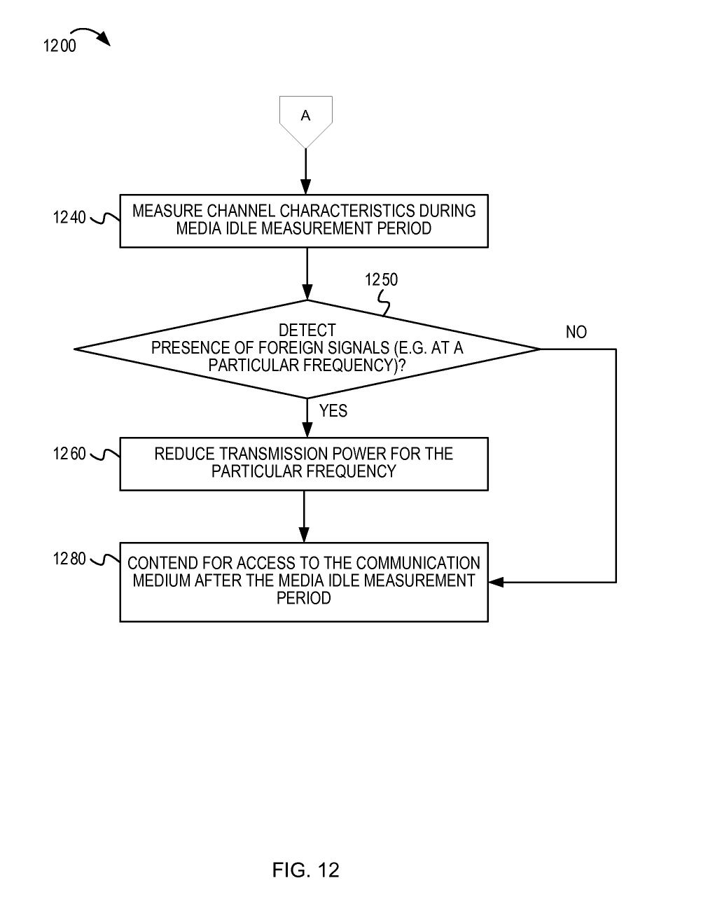

FIG. 12 is a flow diagram (flow 1200) illustrating example operations associated with a media idle measurement period in accordance with an embodiment of this disclosure. The operations may be performed by the transmitting device or any device of the first class of devices that are capable of interpreting a directive for a media idle measurement period that is included in a PDU.

At block 1240, the device may measure channel characteristics during media idle measurement period.

At decision 1250, the device may determine whether it has detected the presence of broadcast radio signals (e.g. at a particular frequency). If the device has detected the presence of broadcast radio signals, then at block 1260, the device may reduce transmission power for the particular frequency. The flow 1200 may continue to block 1280. If, at decision 1250, the device has not detected the presence of broadcast radio signals, the flow 1200 may continue to block 1280.

At block 1280, the device may contend for access to the communication medium after the media idle measurement period.

It should be understood that FIGS. 1A-12 and the operations described herein are examples meant to aid in understanding embodiments and should not be used to limit embodiments or limit scope of the claims. Embodiments may perform additional operations, fewer operations, operations in a different order, operations in parallel, and some operations differently.

As will be appreciated by one skilled in the art, aspects of the present subject matter may be embodied as a system, method, or computer program product. Accordingly, aspects of the present subject matter may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present subject matter are described with reference to flowchart illustrations and/or block diagrams of methods, apparatus (systems) and computer program products according to embodiments of the present subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

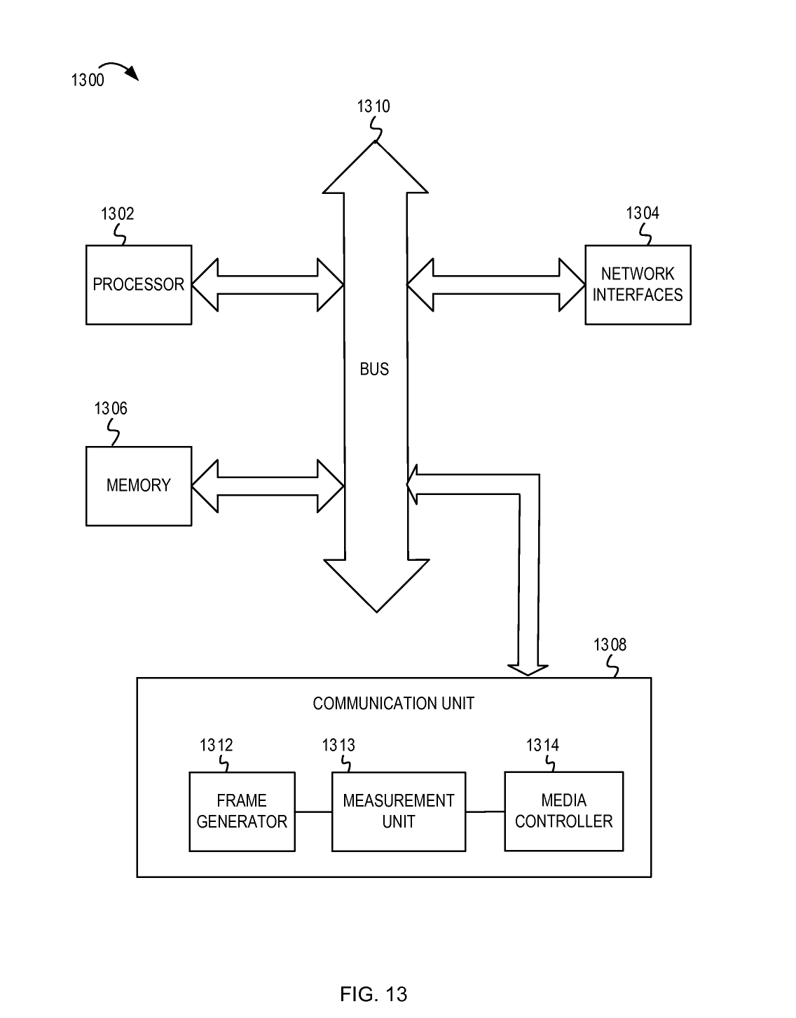

FIG. 13 is an example block diagram of one embodiment of an electronic device 1300 including a communication unit 1308 for implementing embodiments of this disclosure. In some implementations, the electronic device 1300 may be one of a laptop computer, a netbook, a mobile phone, a powerline communication device, a personal digital assistant (PDA), or other electronic systems. The electronic device 1300 includes a processor 1302 (possibly including multiple processors, multiple cores, multiple nodes, and/or implementing multi-threading, etc.). The electronic device 1300 includes a memory 1306. The memory 1306 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 1300 also includes a bus 1310 (e.g., PCI, ISA, PCI-Express, HyperTransport®, InfiniBand®, NuBus, AHB, AXI, etc.), and network interfaces 1304 that include at least one of a wireless network interface (e.g., a WLAN interface, a Bluetooth® interface, a WiMAX interface, a ZigBee® interface, a Wireless USB interface, etc.) and a wired network interface (e.g., an Ethernet interface, a powerline communication interface, etc.). In some implementations, the electronic device 1300 may support multiple network interfaces—each of which is configured to couple the electronic device 1300 to a different communication network.

The electronic device 1300 also includes a communication unit 1308. The communication unit 1308 may comprise a frame generator 1312, a measurement unit 1313 and media controller 1314. It should be understood, that in some embodiments, the communication unit 1308 may also have a dedicated processor (e.g., such as a communication unit comprising a system on a chip, or board with multiple chips, or multiple boards, in which the communication may have one or more dedicated processor(s), in addition to the processor 1302). As described above in FIGS. 1-11, the communication unit 1308 may send a PDU having a new frame format or may receive such a PDU, or both. For example, the frame generator 1312 may prepare a PDU having the new frame format. The measurement unit 1313 may perform channel characteristic measurements during a media idle measurement period and detect for the presence of foreign signals. The media controller 1314 may reduce transmission power for particular frequencies in response to detecting the radio broadcast interference. In another example, the media controller 1314 may cause the network interfaces 1304 to refrain from transmitting during the media idle measurement period.

Any one of these functionalities may be partially (or entirely) implemented in hardware and/or on the processor 1302. For example, the functionality may be implemented with an application specific integrated circuit, in logic implemented in the processor 1302, in a co-processor on a peripheral device or card, etc. Further, realizations may include fewer or additional components not illustrated in FIG. 12 (e.g., video cards, audio cards, additional network interfaces, peripheral devices, etc.). The processor 1302, the memory 1306, and the network interfaces 1304 are coupled to the bus 1310. Although illustrated as being coupled to the bus 1310, the memory 1306 may be coupled to the processor 1302.

While the embodiments are described with reference to various implementations and exploitations, it will be understood that these embodiments are illustrative and that the scope of the disclosed subject matter is not limited to them. In general, techniques for transmitting or receiving a PDU having a frame format supporting enhanced features as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the present subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the present subject matter.

What is claimed is:

1. A method performed by a transmitting device in a network, the method comprising:
preparing a protocol data unit (PDU) for transmission on a communication medium, the PDU having a first frame format known by a first class of devices, the first frame format based at least in part on a second frame format known by a second class of devices, the first frame format differing at least in part from the second frame format, wherein the first frame format and the second frame format are associated with a same contention timing for at least the second class of devices; and
transmitting the PDU via the communication medium.

2. The method of claim 1, wherein the first frame format matches a frame format structure of the second frame format, and one or more fields of the frame format structure are redefined in the first frame format.

3. The method of claim 1, wherein the first frame format uses a same address for a source address field and a destination address field.

4. The method of claim 3, wherein the same address is a media access control (MAC) address of the transmitting device.

5. The method of claim 1, wherein an initial portion of the first frame format matches the second frame format, and wherein the second frame format is specified for a communication protocol used on the communication medium.

6. The method of claim 5, wherein the first frame format is not specified for the communication protocol.

7. The method of claim 1, wherein the PDU includes a directive associated with an enhanced feature supported by the first class of devices.

8. The method of claim 1, further comprising:
including, in a portion of the first frame format, a directive associated with creating a media idle measurement period.

9. The method of claim 8, wherein the media idle measurement period occurs during a transmission period of the PDU.

10. The method of claim 8, wherein the directive includes a time period for the media idle measurement period.

11. The method of claim 10, wherein the time period is shorter than a transmission period of the PDU, and wherein the first class of devices can contend for access to the communication medium sooner than the contention timing for the second class of devices.

12. A method for communicating in a network, the method comprising:
receiving a protocol data unit (PDU) via a communication medium, the PDU having a first frame format known by a first class of devices, the first frame format based at least in part on a second frame format known by a second class of devices, the first frame format differing at least in part from the second frame format, wherein the first frame format and the second frame format are associated with a same contention timing for at least the second class of devices; and
interpreting the PDU based on the first frame format in response to determining that the PDU has the first frame format.

13. The method of claim 12, wherein the first frame format matches a frame format structure of the second frame format, and one or more fields of the frame format structure are redefined in the first frame format.

14. The method of claim 12, further comprising:
determining that the PDU has the first frame format when the PDU has a same address for a source address field and a destination address field.

15. The method of claim 12, wherein the PDU includes a directive associated with an enhanced feature supported by the first class of devices.

16. The method of claim 12, wherein the PDU includes a directive associated with creating a media idle measurement period.

17. The method of claim 16, further comprising:
refraining from transmitting during the media idle measurement period.

18. The method of claim 16, wherein the directive includes a time period for the media idle measurement period.

19. The method of claim 18, wherein the time period is shorter than a transmission period of the PDU, the method further comprising:
refraining from transmitting during the media idle measurement period; and
contending for access to the communication medium after the media idle measurement period.

20. The method of claim 19, wherein said contenting for access occurs sooner than the contention timing associated with the second frame format.

21. An apparatus, comprising:
one or more processors; and
memory to store instructions, which when executed by at least one of the one or more processors, cause the apparatus to:
receive a protocol data unit (PDU) via a communication medium, the PDU having a first frame format known by a first class of devices, the first frame format based at least in part on a second frame format known by a second class of devices, the first frame format differing at least in part from the second frame format, wherein the first frame format and the second frame format are associated with a same contention timing for at least the second class of devices; and
interpret the PDU based on the first frame format in response to determining that the PDU has the first frame format.

22. The apparatus of claim 21, wherein the memory further stores instructions, which when executed by at least one of the one or more processors, cause the apparatus to:
determine that the PDU has the first frame format when the PDU has a same address for a source address field and a destination address field.

23. The apparatus of claim 21, wherein the PDU includes a directive associated with creating a media idle measurement period, and wherein the memory further stores instructions, which when executed by at least one of the one or more processors, cause the apparatus to:
refrain from transmitting during the media idle measurement period.

24. The apparatus of claim 23, wherein the memory further stores instructions, which when executed by at least one of the one or more processors, cause the apparatus to:
contend for access to the communication medium after the media idle measurement period, wherein the directive includes a time period for the media idle measurement period, the time period ending sooner the contention timing associated with the second frame format.

25. A non-transitory machine-readable medium having instructions stored therein, which when executed by a processor causes the processor to perform operations that comprise:
receiving a protocol data unit (PDU) via a communication medium, the PDU having a first frame format known by a first class of devices, the first frame format based at least in part on a second frame format known by a second class of devices, the first frame format differing at least in part from the second frame format, wherein the first frame format and the second frame format are associated with a same contention timing for at least the second class of devices; and
interpreting the PDU based on the first frame format in response to determining that the PDU has the first frame format.

26. The non-transitory machine-readable medium of claim 25, wherein the instructions executed by the processor to perform operations further comprise:
determining that the PDU has the first frame format when the PDU has a same address for a source address field and a destination address field.

27. The non-transitory machine-readable medium of claim 25, wherein the PDU includes a directive associated with creating a media idle measurement period, and wherein the instructions executed by the processor to perform operations further comprise:
refraining from transmitting during the media idle measurement period.

28. The non-transitory machine-readable medium of claim 27, wherein the instructions executed by the processor to perform operations further comprise:
contending for access to the communication medium after the media idle measurement period.
